(19) United States
(12) Patent Application Publication
(10) Pub. No.: US 2014/0184155 A1
(43) Pub. Date: Jul. 3, 2014

(54) TRANSMITTING ANTENNA AND TRANSMITTER FOR WIRELESS POWER CHARGING

(71) Applicant: KOREA ELECTRONICS TECHNOLOGY INSTITUTE, Gyeonggi-do (KR)

(72) Inventor: Cheolung CHA, Seoul (KR)

(73) Assignee: KOREA ELECTRONICS TECHNOLOGY INSTITUTE, Gyeonggi-do (KR)

(21) Appl. No.: 14/132,694

(22) Filed: Dec. 18, 2013

(30) Foreign Application Priority Data
Dec. 27, 2012 (KR) 10-2012-0154160

(51) Int. Cl. H02J 7/02

(52) U.S. Cl. CPC H02J 7/025
USPC 320/109

(57) ABSTRACT

The present invention has been made in an effort to overcome the disadvantage that a user has to consciously adjust the positions of a wireless power transmitter and a wireless power receiver. The transmitting antenna for wireless power charging, which wirelessly transmits power to charge a device, includes a first antenna coil section for producing a magnetic field in a first direction, and a second antenna coil section for producing a magnetic field in a second direction. Accordingly, the three-dimensional transmitting antenna can minimize decreases in efficiency caused by the position and direction of the receiver and maximize reception efficiency at a particular point or within a particular range.

### CROSS-REFERENCE TO RELATED APPLICATION

This application claims priority to and the benefit of Korean Patent Application No. 10-2012-0154160 filed in the Korean Intellectual Property Office on Dec. 27, 2012, the entire contents of which are incorporated herein by reference.

### BACKGROUND OF THE INVENTION

(a) Field of the Invention

The present invention relates to a transmitting antenna and transmitter for wireless power charging, and more particularly, to a transmitting antenna and transmitter for wireless power charging which maximize reception efficiency by giving spatial freedom to a wireless power receiver and focusing a magnetic field on a particular position.

(b) Description of the Related Art

Typically, each battery powered device requires its own charger and power source, which is usually an AC power outlet. This becomes unwieldy when many devices need charging, each requiring its own AC power source. In recent years, approaches have been developed that use wireless power transmission between a transmitter and a device to be charged.

A wireless charging system using electromagnetic induction has been used as a wireless power transmission technology for wireless energy transfer. For example, an electric toothbrush or wireless razor is charged via electromagnetic induction, and wireless charging products which are capable of charging portable devices have been recently released, such as cell phones, PDAs, MP3 players, and laptop computers, using electromagnetic induction. However, the electromagnetic induction, in which current is induced from one coil to another through a magnetic field, is very sensitive to the distance between the coils and their relative positions. Hence, the transmission efficiency is rapidly reduced if the two coils become farther away or are misaligned, even slightly. For this reason, an electromagnetic induction type of charging system is disadvantageous in that it can be used only within a short distance of no more than several centimeters.

Many research institutes including MIT have been recently conducting research on the wireless power transmission technology using magnetic resonance, because this technology can achieve a longer transfer distance than the conventional electromagnetic induction and shows better power transfer efficiency.

U.S. Pat. No. 7,741,735 discloses a wireless power transmission technology using magnetic resonance. This patent discloses a technology of transferring energy over a longer distance, compared to the conventional electromagnetic induction, because two resonators having the same frequency tend to be coupled together although they do not affect other non-resonators around them.

Coil antennas for transmission and reception are used to transfer wireless power to portable mobile devices and sensor nodes distributed over a wireless sensor network. However, a coil antenna for producing a magnetic resonance has limitations in implementation and manufacturing when it is mounted on a mobile device because of its large volume. Thus, the development of single-layer, planar coil antennas, which are easy to insert into a cell phone, is underway.

FIG. 1 and FIG. 2 are views showing a structure of a wireless power transmitting antenna 10 incorporated in a conventional planar wireless power transmitter. As shown in FIG. 1, the conventional planar wireless power transmitter (not shown) is a pad type, and the coil antenna incorporated in the wireless power transmitter also has a planar structure. To ensure that the conventional wireless power transmitter of FIG. 1 achieves maximum charging efficiency, the user has to consciously place their cell phone at a given position of the pad type wireless power transmitter.

As shown in FIG. 2, when current flows counterclockwise in the X-Y plane of the planar coil antenna, an electric field is formed on the Z axis. Thus, maximum charging efficiency can be attained when the antenna 20 of the power transmitter is placed in a direction perpendicular to the electric field. As such, the conventional planar wireless power transmitter has the problem that the reception efficiency rapidly decreases depending on the angle of arrangement of the antenna 10 incorporated in the wireless power transmitter (charger) and the antenna 20 incorporated in the power receiver to be charged. This makes the user more aware of how to position their cell phone incorporating the power receiver. Due to this, the wireless charging technology is not as convenient in use as the conventional wired charging technology.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to overcome the disadvantage that a user has to consciously adjust the positions of a wireless power transmitter and a wireless power receiver.

Furthermore, the present invention has been made in an effort to maximize reception efficiency by allowing magnetic fields to overlap at a particular position.

An exemplary embodiment of the present invention provides a transmitting antenna for wireless power charging,

which wirelessly transmits power to charge a device, the transmitting antenna including

a first antenna coil section for producing a magnetic field in a first direction, and a second antenna coil section for producing a magnetic field in a second direction.

The first magnetic field and the second magnetic field may overlap at a first position, and the first direction and the second direction may be nearly orthogonal.

The first antenna coil section may have a coil wound in a circular or rectangular shape in a first plane, and the second antenna coil section may have a coil wound along a cylindrical surface perpendicular to the first plane. The transmitting antenna for wireless power charging may be installed in a cup holder.

The first antenna coil section may have a structure in which a coil is wound in a [symbol] -shape or rectangular shape in the first plane, and the second antenna coil section may have a structure in which a coil is wound in a [symbol] -shape or rectangular shape in a second plane.

Another embodiment of the present invention provides a transmitter for wireless power charging,

which wirelessly transmits power to a receiver having a receiving antenna to charge a device, the transmitting antenna including:

a transmitting antenna including a first antenna coil section for producing a magnetic field in a first direction and a second antenna coil section for producing a magnetic field in a second direction; and a transmitting circuit for providing an oscillation signal to enable the transmitting antenna to wirelessly transmit power.

The transmitter and the receiver may have the same resonance frequency.

According to the present invention, decreases in efficiency caused by the position and direction of the receiver can be minimized by the stereoscopic arrangement or configuration of the transmitter or receiver's antenna having a three-dimensional structure. This relieves the burden of a user having to be aware of how to position the receiver, and provides more convenience to the user because their cell phone can be charged without the user recognizing and being aware of it.

Moreover, according to the present invention, reception efficiency can be maximized at a particular point or within a particular range by efficient configuration and arrangement of this three-dimensional structure.

### BRIEF DESCRIPTION OF THE DRAWINGS

To illustrate the technical solutions according to embodiments of the present invention or in the prior art more clearly, the accompanying drawings are introduced briefly in the following. Like reference numerals in each of the drawings denote like elements in other drawings. Obviously, the accompanying drawings in the following descriptions are some embodiments of the present invention, and persons of ordinary skill in the art may obtain other drawings from the accompanying drawings without making creative efforts.

FIG. 1 and FIG. 2 are views showing an antenna structure for a conventional planar wireless power transmitter.

FIG. 3 and FIG. 4 are views showing a wireless power transmitting antenna structure according to a first exemplary embodiment of the present invention.

FIG. 5 to FIG. 7 are views showing currents and magnetic fields in the wireless power transmitting antenna according to the first exemplary embodiment of the present invention.

FIG. 11 to FIG. 14 show simulation results illustrating the efficiency of the wireless power transmitting antenna structure according to the first exemplary embodiment of the present invention.

FIG. 8 is a view showing a wireless power transmitting antenna structure according to a second exemplary embodiment of the present invention.

FIG. 9 and FIG. 10 are views showing currents and magnetic fields in the wireless power transmitting antenna according to the second exemplary embodiment of the present invention.

FIG. 15 and FIG. 16 show simulation results illustrating the efficiency of the wireless power transmitting antenna structure according to the second exemplary embodiment of the present invention.

### DETAILED DESCRIPTION OF THE EMBODIMENTS

Technical solutions and advantages of embodiments of the present invention are clearly and completely described in the following with reference to the accompanying drawings. Obviously, the embodiments in the following descriptions are merely part of rather than all of the embodiments of the present invention. All other embodiments obtained by persons of ordinary skill in the art based on the embodiments of the present invention without making creative efforts shall fall within the protection scope of the present invention.

In order to clarify the present invention, parts that are not related to the description are omitted, and similar elements are given similar reference numerals throughout the specification.

In the following description, well-known functions or constructions are not described in detail to avoid obscuring the invention in unnecessary detail.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising” will be understood to imply the inclusion of stated elements but not the exclusion of any other elements.

As used herein, the term “wireless power” refers to a certain form of energy associated with a magnetic field, electromagnetic field, etc. transmitted from a transmitter to a receiver without the use of physical electromagnetic conductors.

A wireless power charging system according to an exemplary embodiment of the present invention includes a transmitter (not shown) and a receiver (not shown).

The transmitter, which transmits wireless power for charging, is supplied with input power, and the receiver charges a device by the wireless power transmitted from the transmitter. In the exemplary embodiment of the present invention, the transmitter and the receiver may be configured according to the resonance relationship between them. By setting almost the same resonance frequency for the receiver and the transmitter, power loss between the transmitter and the receiver can be minimized.

The transmitter includes a transmitting antenna for providing means for wireless power transmission, and the receiver includes a receiving antenna for providing means for energy reception. The transmitting and receiving antennas are sized according to applications and devices associated with them.

The transmitter further includes a transmitting circuit for providing an oscillation signal that enables the transmitting antenna to transmit wireless power. In the exemplary embodiment of the present invention, the transmitter may operate from 100 KHz to 300 MHz.

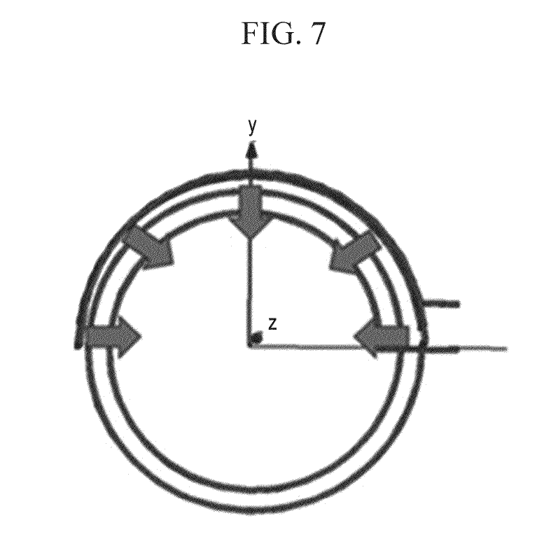

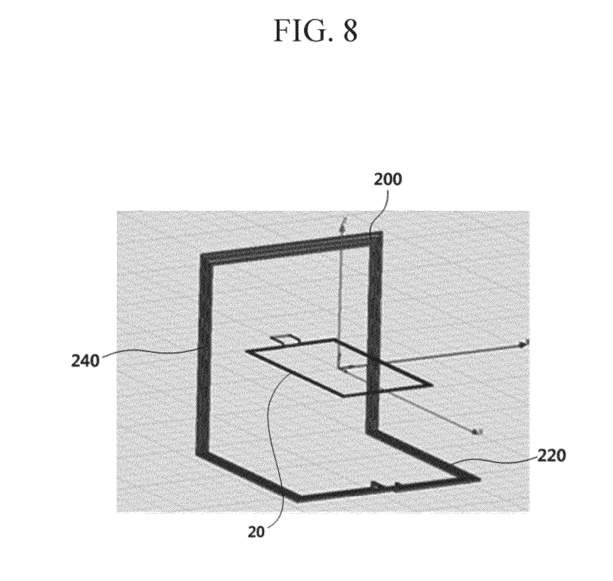

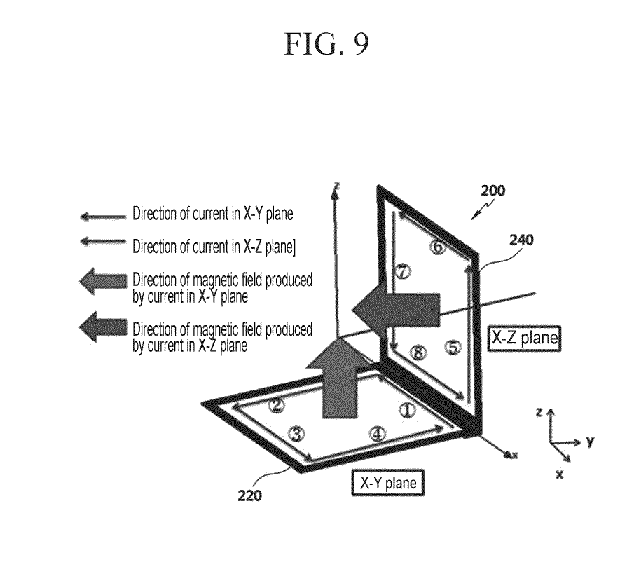

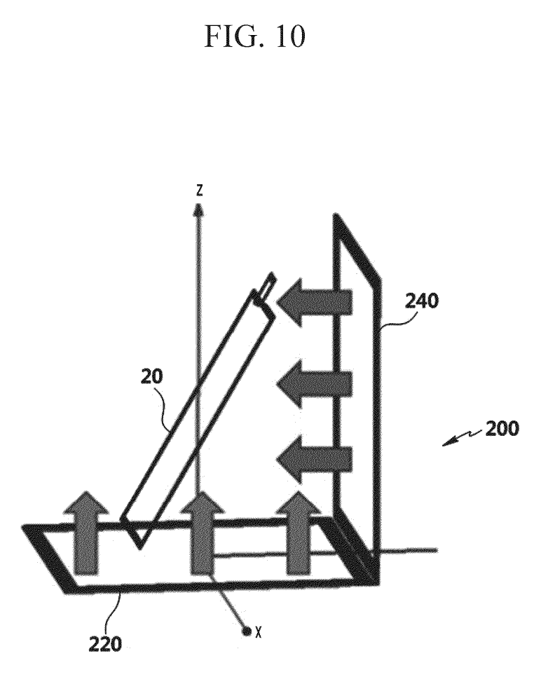

Next, a transmitting antenna structure for wireless power charging according to a first exemplary embodiment of the present invention will be described with reference to FIG. 3 to FIG. 7.

According to the first exemplary embodiment of the present invention, a cup-holder type of antenna structure for wireless power charging incorporated in a cup holder type of charger for a cell phone is disclosed. While a conventional planar non-contact charger can be charged after the user adjusts the positions of the wireless power transmitter and the receiver, the transmitting antenna for wireless power charging can be charged regardless of the angle or position at which the user puts the cell phone since it has a cup holder-like structure and can be installed in various places including in a cup holder in a car, on a table, etc.

As shown in FIG. 3, the antenna 100 for wireless power charging according to the first exemplary embodiment of the present invention has a three-dimensional structure, and can achieve increases in efficiency as magnetic fields overlap at a desired position and within a desired range by winding a coil in one plane in a cylindrical shape (or any desired shape such as a rectangle) and then keep winding it in another plane in a desired shape.

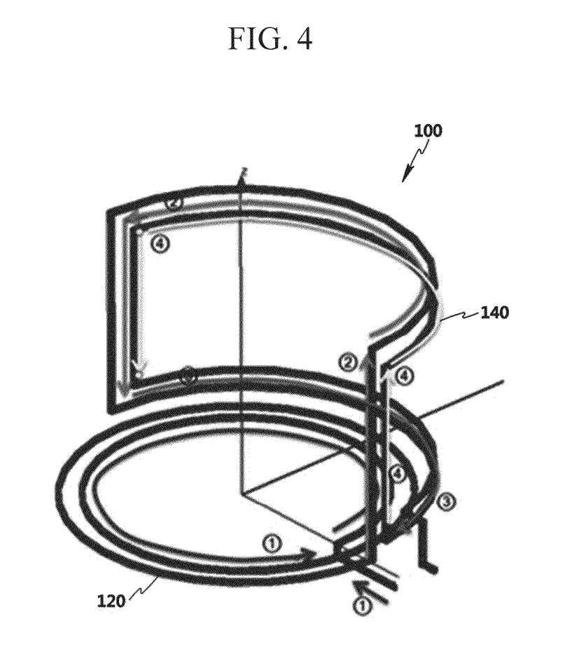

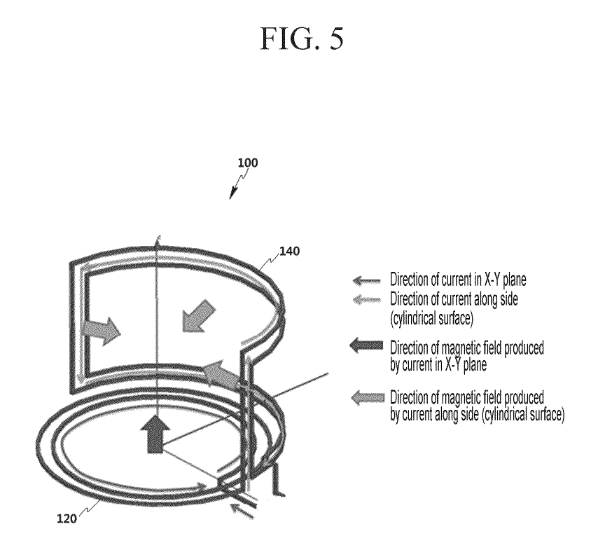

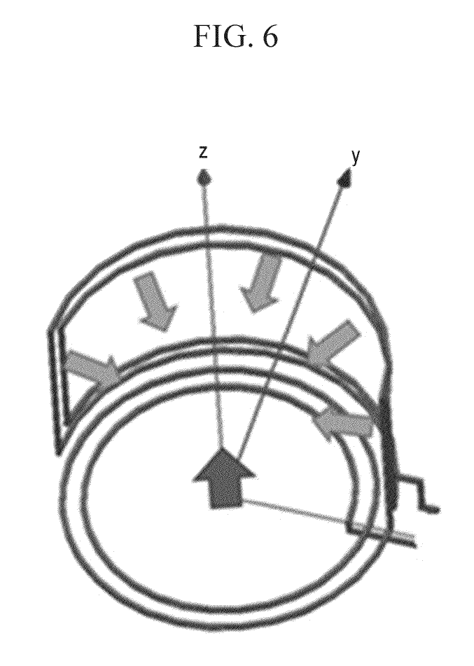

As shown in FIG. 4 and FIG. 5, the antenna 100 for wireless power charging according to the first exemplary embodiment of the present invention includes a first antenna coil section 120 for producing a magnetic field in a first direction, and a second antenna coil section 140 for producing a magnetic field in a second direction.

One end of the first antenna coil section 120 is supplied with current output from a transmitting circuit (not shown), and the other end of the first antenna coil section 120 is connected to one end of the second antenna coil section 140. The other end of the second antenna coil section 140 is connected to the transmitting circuit.

In FIG. 4 and FIG. 5, the first antenna coil section 120 has a coil structure in which a coil is wound N times in a cylindrical shape in the X-Y plane. Current flows counterclockwise in the first antenna coil section 120, and a first magnetic field produced by the first antenna coil section 120 is directed toward the Z axis. The strength of the first magnetic field depends on the strength of the current flowing in the first antenna coil section 120 and the number N of turns of the coil in the X-Y plane.

The second antenna coil section 140 has a coil structure in which a coil is wound M times along a cylindrical surface perpendicular to the X-Y plane. As shown in FIG. 5 to FIG. 7, a second magnetic field produced by the second antenna coil section 140 flows toward the center of the cylinder, and the strength of the first magnetic field depends on the strength of the current flowing in the second antenna coil section 140 (which is the same as the current flowing in the first antenna coil section 120) and the number M of turns of the coil along the cylindrical surface.

As the transmitting antenna for wireless power charging according to the first exemplary embodiment of the present invention has a three-dimensional structure including the first antenna coil section 120 for producing a magnetic field in the first direction and the second antenna coil section 140 for producing a magnetic field in the second direction, power reception efficiency, which varies with the angle between the receiving coil antenna and a magnetic field generated by the transmitting antenna for wireless power charging, can be increased, as described later.

Moreover, the transmitting antenna for wireless power charging according to the first exemplary embodiment of the present invention can maximize reception efficiency by allowing magnetic fields to overlap at a particular position since the first magnetic field produced by the first antenna coil section 120 is directed toward the Z axis and the second magnetic field produced by the second antenna coil section 140 is directed toward the center of the cylinder. That is, according to the first exemplary embodiment of the present invention, if a device (e.g., cell phone) to be charged is at a particular position, like inside a cup holder, reception efficiency can be maximized.

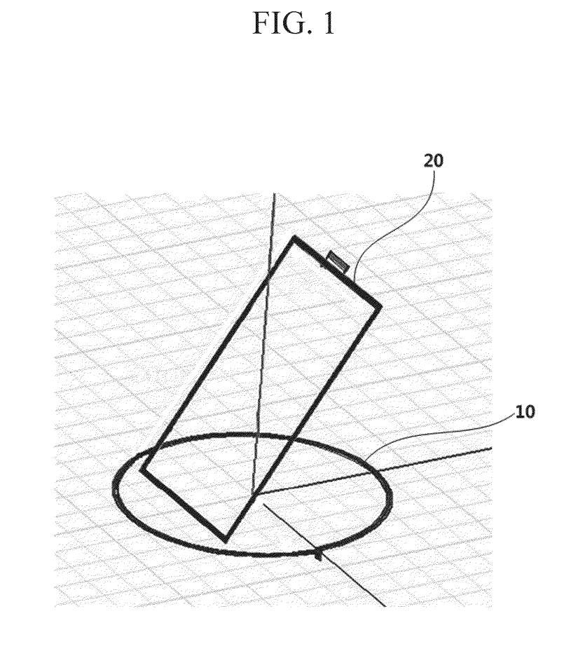

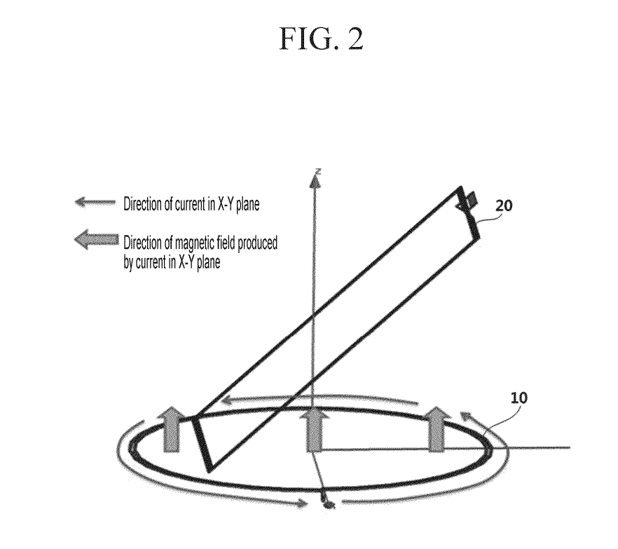

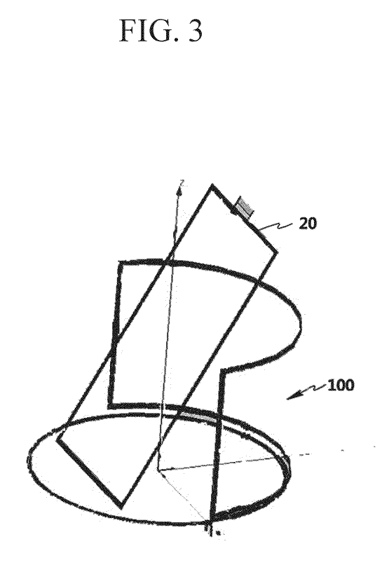

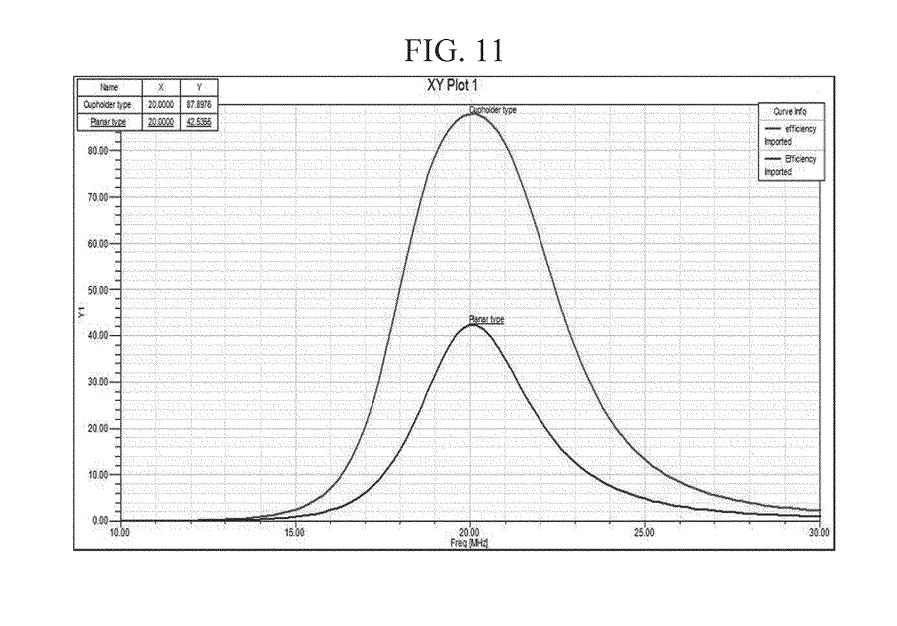

FIG. 11 to FIG. 14 show simulation results of reception efficiency comparisons between the antenna structure for wireless power charging according to the first exemplary embodiment of the present invention and a conventional antenna structure for wireless power charging shown in FIG. 1. Specifically, the figures show comparisons of the two structures' efficiencies versus angle φ of rotation of the receiver's coil antenna with respect to the transmitter's coil antenna in the X-Y plane.

In FIG. 11, the angle of rotation of the receiver's coil antenna with respect to the transmitter's coil antenna is 0°. It is found that the reception efficiency of the antenna structure for wireless power charging according to the first exemplary embodiment of the present invention is about 88%, which is about 45% higher than the reception efficiency (43%) of the conventional antenna structure for wireless power charging.

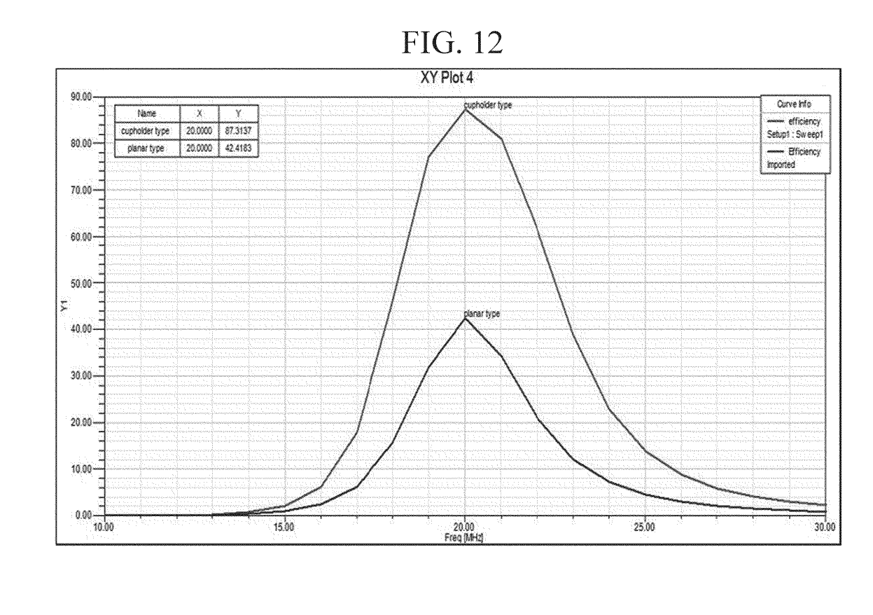

In FIG. 12, the angle of rotation of the receiver's coil antenna with respect to the transmitter's coil antenna is ±20°. It is found that the reception efficiency (about 87%) of the antenna structure for wireless power charging according to the first exemplary embodiment of the present invention is about 45% higher than the reception efficiency (42%) of the conventional antenna structure for wireless power charging.

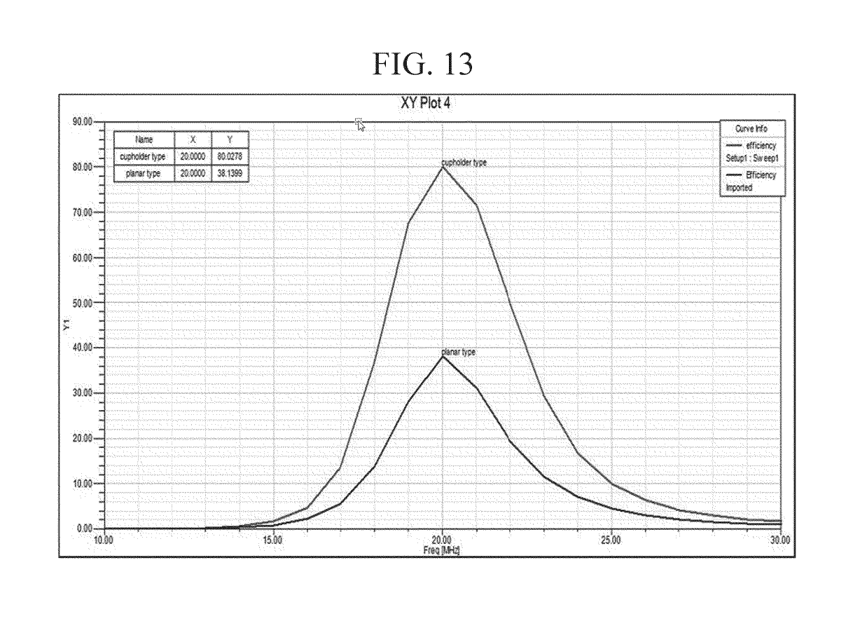

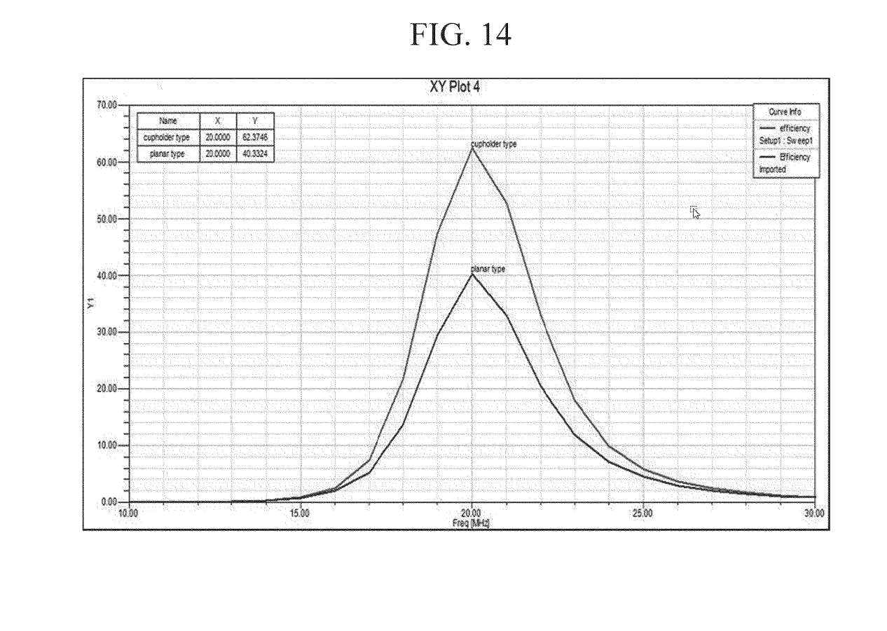

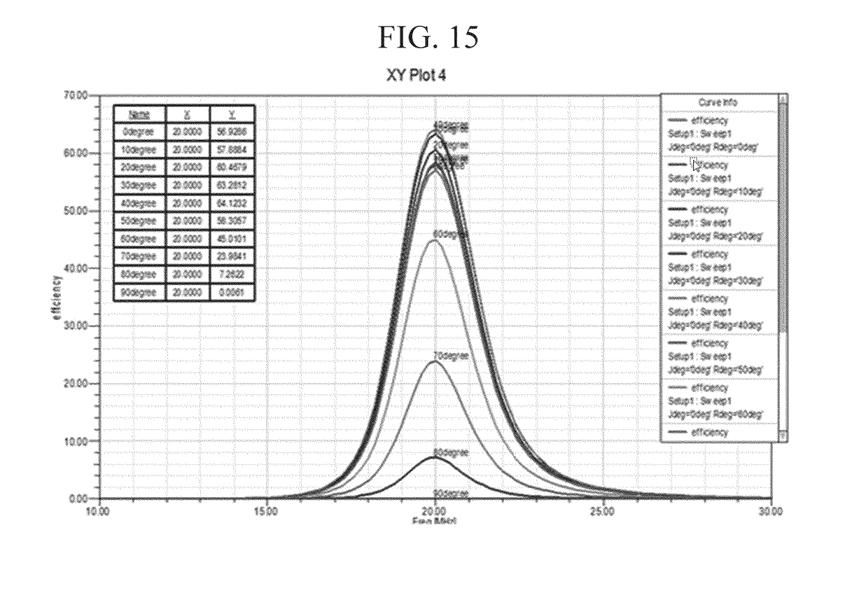

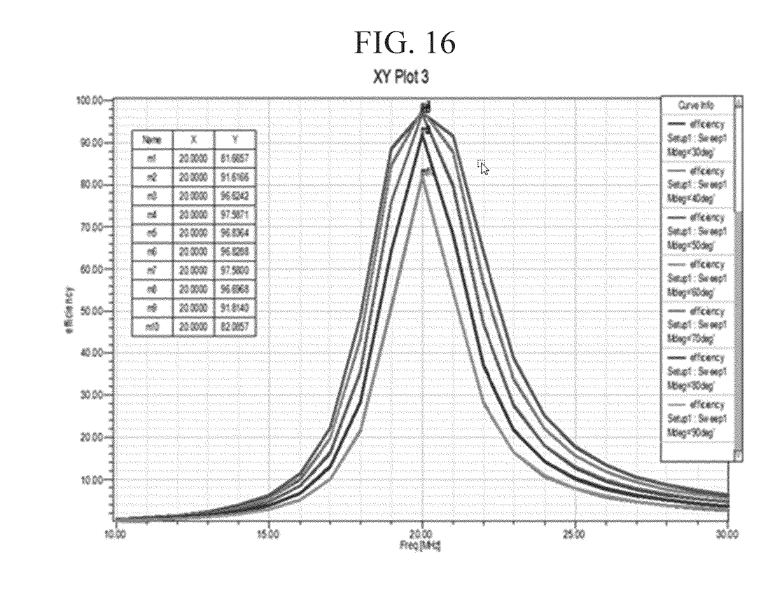

In FIG. 13 and FIG. 14, the angle of rotation of the receiver's coil antenna with respect to the transmitter's coil antenna is ±40° and ±60°, respectively. It is found that the reception efficiency of the antenna structure for wireless power charging according to the first exemplary embodiment of the present invention is about 42% and 45% higher, respectively, than the reception efficiency of the conventional antenna structure for wireless power charging.

As described above, while the coil antenna for a conventional two-dimensional, single planar coil transmitter has low power reception efficiency due to changes in the angle between the receiving coil antenna and a magnetic field generated by the transmitting antenna for wireless power charging, the three-dimensional, single linear coil antenna structure according to the first exemplary embodiment of the present invention can achieve increases in power reception efficiency which vary with the angle between the receiving coil antenna and a magnetic field generated by the transmitting antenna for wireless power charging.

Next, an antenna structure for wireless power charging according to a second exemplary embodiment of the present invention will be described with reference to FIGS. 8 to 10.

If the user sits on a chair with their cell phone inside a bag or pocket, the relative position and angle of the cell phone in the bag or pocket vary with respect to those of the wireless power charger. In this case, the charging efficiency may be abruptly reduced. The antenna structure for charging according to the second exemplary embodiment of the present invention is intended to overcome this drawback, and enables a cell phone to be charged without the user's recognizing and being aware of it.

The transmitting antenna for wireless power charging according to the second exemplary embodiment of the present invention shown in FIG. 8 to FIG. 10 has an L-type three-dimensional structure, which can achieve high reception efficiency by allowing magnetic fields to overlap, regardless of the angle of arrangement of the cell phone inside the user's bag or pocket.

As shown in FIG. 8 to FIG. 10, the antenna 200 for wireless power charging according to the second exemplary embodiment of the present invention includes a first antenna coil section 220 for producing a magnetic field in a first direction and a second antenna coil section 240 for producing a magnetic field in a second direction.

The first antenna coil section 220 has a coil structure in which a coil is wound in a [symbol] -shape or rectangular shape in the X-Y plane. Current flows counterclockwise in the first antenna coil section 220, and a first magnetic field produced by the first antenna coil section 220 is directed toward the Z axis.

The second antenna coil section 240 has a coil structure in which a coil is wound in a [symbol] -shape or rectangular shape in the X-Z plane. Current flows counterclockwise in the second antenna coil section 240, and a second magnetic field produced by the second antenna coil section 240 is directed toward the −Y axis.

Moreover, the transmitting antenna for wireless power charging according to the second exemplary embodiment of the present invention can maximize reception efficiency if a device (e.g. a cell phone) to be charged is at a particular position since the first magnetic field produced by the first antenna coil section 220 is directed toward the Z axis and the second magnetic field produced by the second antenna coil section 240 is directed toward the −Y axis.

FIG. 15 and FIG. 16 show simulation results of reception efficiency comparisons between the antenna structure for wireless power charging according to the second exemplary embodiment of the present invention and a conventional antenna structure for wireless power charging shown in FIG. 1. Specifically, the figures show comparisons of the two structures' efficiencies versus angle φ of rotation of the receiver's coil antenna with respect to the transmitter's coil antenna in the X-Y plane. In FIG. 15, the angle of rotation of the receiver's coil antenna with respect to the transmitter's coil antenna in the conventional antenna structure for wireless power charging is ±10, ±20, ±30, ±40, ±50, ±60, ±70, ±80, and ±90, respectively. As shown in FIG. 15, the transmitter's antenna structure according to the conventional art shows low reception efficiency ranging from about 0% to 64%, which suggests that it is difficult to achieve spatial freedom.

In FIG. 16, the angle of rotation of the receiver's coil antenna with respect to the transmitter's coil antenna in the antenna structure for wireless power charging according to the second exemplary embodiment of the present invention is ±30, ±40, ±50, ±60, ±70, ±80, and ±90, respectively. As shown in FIG. 16, the transmitter's antenna structure according to the second exemplary embodiment of the present invention shows reception efficiency ranging from about 81% to 97%, which suggests that spatial freedom can be achieved.

Hence, the three-dimensional, single linear coil antenna structure according to the second exemplary embodiment of the present invention can achieve increases in power reception efficiency which vary with the angle between the receiving coil antenna and a magnetic field generated by the transmitting antenna for wireless power charging.

The drawings referred to hereinabove and the detailed description are presented for illustrative purposes only, and are not intended to define meanings or limit the scope of the exemplary embodiments as set forth in the following claims. Those skilled in the art will understand that various modifications and equivalent embodiments are possible. Consequently, the true technical protective scope of the exemplary embodiments must be determined based on the technical spirit of the appended claims.

### DESCRIPTION OF SYMBOLS

20 receiving antenna, 100, 200 transmitting antenna

120, 220 first antenna coil section, 220, 240 second antenna coil section

What is claimed is:

1. A transmitting antenna for wireless power charging, which wirelessly transmits power to charge a device, the transmitting antenna comprising:
a first antenna coil section for producing a magnetic field in a first direction; and
a second antenna coil section for producing a magnetic field in a second direction,
wherein the first magnetic field and the second magnetic field overlap at a first position.

2. The transmitting antenna of claim 1, wherein the first direction and the second direction are nearly orthogonal.

3. The transmitting antenna of claim 1, wherein
the first antenna coil section has a coil wound in a circular or rectangular shape in a first plane, and
the second antenna coil section has a coil wound along a cylindrical surface perpendicular to the first plane.

4. The transmitting antenna of claim 3, wherein the transmitting antenna for wireless power charging is installed in a cup holder.

5. The transmitting antenna of claim 1, wherein
the first antenna coil section has a structure in which a coil is wound in a [symbol] -shape or rectangular shape in the first plane, and
the second antenna coil section has a structure in which a coil is wound in a [symbol] -shape or rectangular shape in a second plane.

6. A transmitter for wireless power charging, which wirelessly transmits power to a receiver having a receiving antenna to charge a device, the transmitting antenna comprising:
a transmitting antenna comprising a first antenna coil section for producing a magnetic field in a first direction and a second antenna coil section for producing a magnetic field in a second direction; and
a transmitting circuit for providing an oscillation signal to enable the transmitting antenna to wirelessly transmit power.

7. The transmitter of claim 6, wherein
the first antenna coil section has a coil wound in a circular or rectangular shape in a first plane, and
the second antenna coil section has a coil wound along a cylindrical surface perpendicular to the first plane.

8. The transmitter of claim 6, wherein
the first antenna coil section has a structure in which a coil is wound in a [symbol] -shape or rectangular shape in the first plane, and
the second antenna coil section has a structure in which a coil is wound in a [symbol] -shape or rectangular shape in a second plane.

9. The transmitter of claim 6, wherein the transmitter and the receiver may have the same resonance frequency.
